(19) United States
(12) Patent Application Publication
(10) Pub. No.: US 2002/0121465 A1
(43) Pub. Date: Sep. 5, 2002

(54) Portable, towable filtration unit

(76) Inventor: Tim Gannon, Bakersfield, CA (US)

Correspondence Address: PARENT PATENT RESEARCH, INC, 600 NORTH PICKETT STREET, ALEXANDRIA, VA, 22304

(21) Appl. No.: 09/785,293

(22) Filed: Feb. 20, 2001

(51) Int. Cl. B07B 1/49

(52) U.S. Cl. 209/421; 209/352

(57) ABSTRACT

A mobile, portable filter mechanism is disclosed that allows a single user both to transport and treat liquid. The device consists of a trailer-type vehicle that includes an expanded metal screen lying inside the rectangular body. A disposable filter bag is placed upon the screen and a pump is used to fill the bag. The treated water flows out of the bag and is collected in the collection basin located in the trailer body. A plug is located in the rear of the trailer to allow the treated liquid to be drained or pumped to another filter stage. Additionally, a hydraulic ram, of the standard dump-bed type is part of the apparatus and allows the user to drain the collected liquid and to aid in the disposition of the filter bag.

### BACKGROUND OF THE INVENTION

1. Field of the Invention

The present invention relates generally to liquid purification. More specifically, it relates to a portable water purification system that involves a number of steps: the first step involving the elimination of particulate matter from the liquid. Even more specifically, the invention addresses the problem involved when the particulate matter is between the values of 100 and 500 microns. Even more specifically, it relates to a portable initial purification system that allows the user to transport the device to a specific location and address the immediate situation such that major particulates are removed from the liquid before further processing, and that these particulates are removed on-site. Even more particularly, the present invention allows the user to take the unit on-site and make the initial removal of the particulates, isolating them from the environment, and transporting them from the site. Yet even more particularly, the instant invention allows a single user to transport the unit, operate the same, and deliver the treated effluent to any desired location.

2. DESCRIPTION OF THE PRIOR ART

In many situations, a small amount of contaminated liquid will be discovered in a specific location. For example, a ditch could be uncovered after a period of bad weather and be found to partially full of water. This water will be full of particulate matter that must be removed before any workers will be allowed in the area, especially if there is any potential contamination of the liquid by a hazardous or noxious material. Presently, the portable filtration systems that exist have been clumsy affairs and overly complicated. The present invention seeks to alleviate this situation by providing a portable filtration device that is substantially entirely contained in a trailer that can be towed by any type of vehicle. A pump, separate from the trailer is used to fill a filtration bag that sits on an expanded metal screen. The filtered water collects in the bottom of the trailer and may be immediately drained from the trailer locally or transported to another location for disposal. Additionally, a hydraulic ram is included to tilt the holding tank so that all the liquid may be drained.

During a search at the U.S. Patent and Trademark Office, a number of relevant patents were uncovered and they will be discussed below.

U.S. Pat. No. 6,152,308 issued to Clarence R. Kreiser et al. on Nov. 28, 200 discloses a mobile classifier for aggregates. This is dissimilar from the present invention in that no expanded metal platform to support the disposable filter bag, as is required by the instant invention, is disclosed.

In the European Patent Document No.

165,883 a mobile filter unit is disclosed. As in the Kreiser et al. patent above however, the structure is completely unlike that of the instant invention.

Thus, while the foregoing overview of prior art indicates it to be well known to provide various portable mobile filter mechanisms, none of the inventions discussed above, either alone or in combination, describe the instant invention as claimed.

### SUMMARY OF THE INVENTION

To achieve the foregoing and other advantages, the present invention, briefly described, provides a mobile, portable filter mechanism that allows a single user both to transport and treat liquid. The device consists of a trailer-type vehicle that includes an expanded metal screen lying inside the rectangular body. A disposable filter bag is placed upon the screen and a pump is used to fill the bag. The treated water flows out of the bag and is collected in the collection basin located in the trailer body. A plug is located in the rear of the trailer to allow the treated liquid to be drained or pumped to another filter stage. Additionally, a hydraulic ram, of the standard dump-bed type is part of the apparatus and allows the user to drain the collected liquid and to aid in the disposition of the filter bag.

Thus it is a principal object of the invention to provide a portable and towable filtration unit that allows a single user to travel to and treat water or other liquid contaminated by particulates on-site.

It is a further object of the invention to provide a portable and towable filtration unit that may be towed behind any standard truck or SUV-type vehicle equipped with a towbar.

Still yet a further object of the invention is to provide a portable and towable filtration unit that uses a disposable filter bag placed on an expended metal screen to remove the particulate matter from the liquid.

Yet another object of the invention is to provide a portable and towable filtration unit that allows the user to transport the treated liquid to another location, if desired, for either disposal or for further treatment.

Still yet another object of the invention is to provide a portable and towable filtration unit that includes a hydraulic ram to aid the user in draining the collection basin and to remove the used filter bag.

These together with still other objects of the invention, along with the various features of novelty that characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and the above objects as well as objects other than those set forth above will become more apparent after a study of the following detailed description thereof. Such description makes reference to the annexed drawings wherein:

FIG. 1 is a partially cut-away view of the instant invention showing the disposable filter bag placed on the expanded metal screen and with the treated liquid falling into the collection basin portion of the device.

FIG. 2 is a side view of the instant invention.

FIG. 3 is a top view of the invention, showing the expanded metal screen extending completely across the top of the collection basin.

FIG. 4 is a rear view of the invention showing the drainage plug.

FIG. 5 is a side view of the invention showing the hydraulic ram fully extended

### DESCRIPTION OF THE PREFERRED EMBODIMENTS

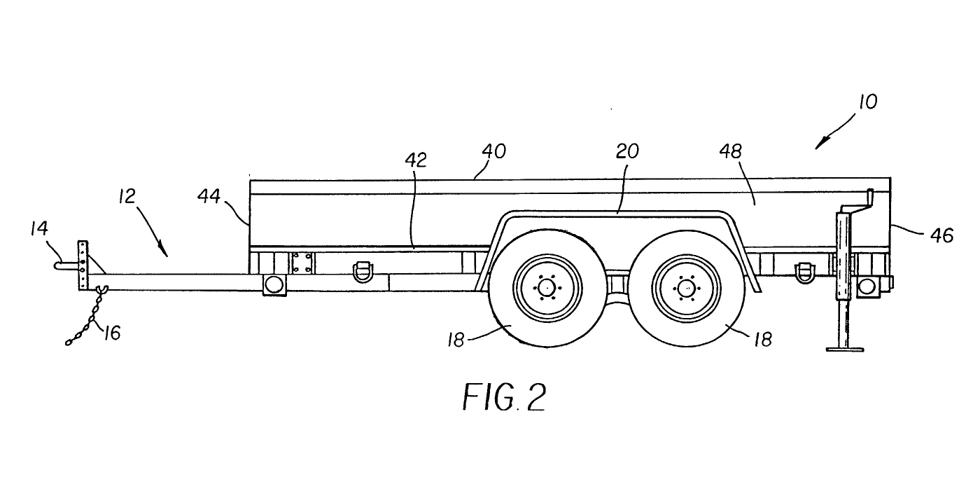

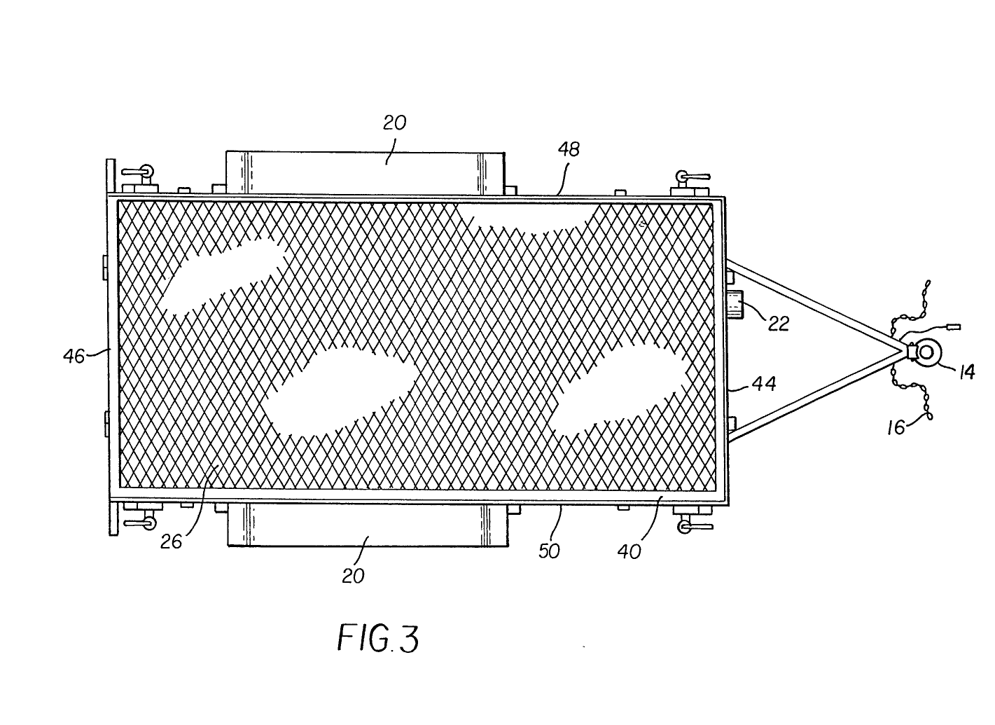

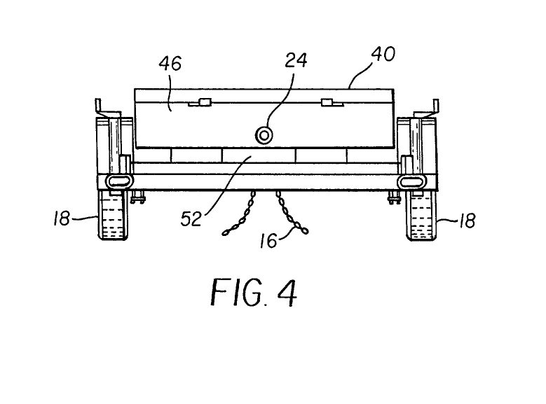

Turning first to FIGS. 2, 3, and 4, the outward features of the present invention will be discussed. In the preferred embodiment described herein, the invention, generally indicated at 10, has the outward appearance of a box-like, rectangular trailer with an open top 40, a sealed bottom 42, a front wall 44, a rear wall 46 and two side walls 48 and 50. The size of this embodiment is approximately 14 feet long by five feet wide and the apparatus is about one and a half feet deep. The front portion 12 includes a trailer hitch 14, including the safety chain 16. Trailer hitch 14, in the contemplated embodiment, is a standard trailer hitch adapted to be attached to the rear of a vehicle such as pickup truck or the like. Furthermore, in the embodiment discussed here, the filter housing trailer 10 includes four wheels each indicated at 18. The wheels 18 are contained in the wheel wells 20, located proximate the side walls 48, 50, as best seen in FIGS. 3 and 4. The front wall 44 includes the liquid input port, indicated at 22 in FIG. 3. The liquid output port or drain is located on the rear wall 46 seen in FIG. 4 and is indicated at 24. It should be emphasized that the number of wheels 18, the precise shape of the trailer housing 10, the location of the input and output ports (22 and 24, respectively) form no part of the overall inventive concept and that a skilled practitioner could alter these in many ways without departing from the spirit of the instant invention.

Turning now first to FIG. 3, the support screen 26 will be described. In the preferred embodiment, the screen 26, as mentioned above, extends completely across the body of the trailer housing 10. In the embodiment described herein, the screen 26 is made from an expanded metal, such as carbon steel. The strands would be approximately 0.15 inches in width and 0.13 inches in thickness. The size of the mesh openings would be approximately 0.7 inches in width and 1.5 inches in thickness. This gauge of commonly available expanded metal material provides sufficient strength to both support the disposable filter bag (discussed further below) and to allow the treated liquid to drain into the collection basin, as will be discussed hereinafter.

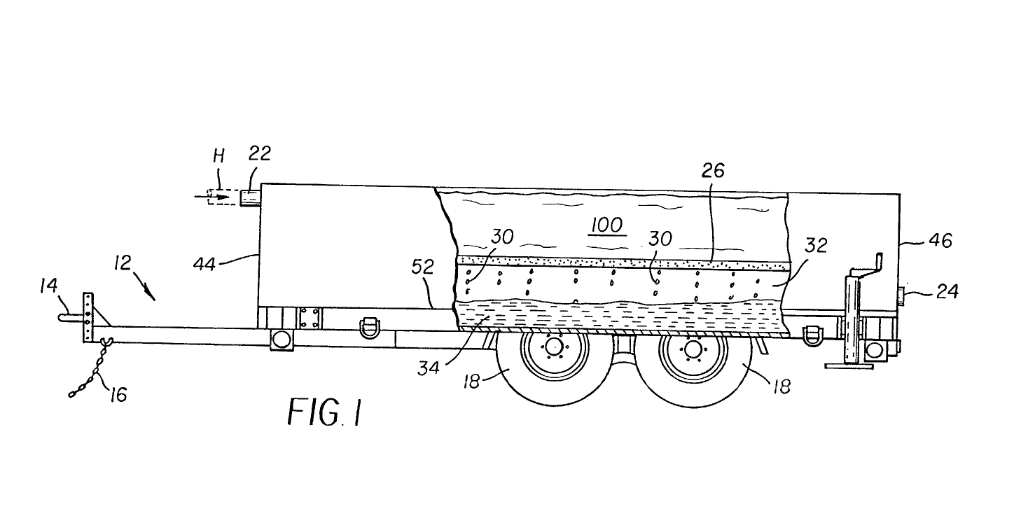

Now the discussion will turn to the details of the filter bag (Indicated at 100 in FIG. 1). The preferred filter bag used in conjunction with the present invention is the DIRTBAG(tm) manufactured by ACF Environmental Inc. of Richmond Va. These bags have a flow rate of approximately 70-80 square feet per minute and are designed to accommodate a four inch hose. Of course it should be understood that other types of filter devices or apparatus could be used with the instant invention and that the bag described herein is only the exemplary example.

In use, the present invention 10 is towed or otherwise transported to the desired location. This location could be a contaminated pool, artificial or otherwise, a construction site having a large amount of standing water, a ditch or trench with the same, or even a location where sediment filled runoff needs to be controlled. Again, one of the advantages of the instant invention is that a single person can transport and set up the apparatus. In one contemplated circumstance, say a pickup truck (not shown) is used to tow the filter trailer 10. A pump (also not shown) can be carried in the back of the truck and when the site is reached, one end of a hose (shown in broken lines in FIG. 1 and indicated at H) is placed in the particulate contaminated water and the other is attached to the input port, indicated at 28 in FIG. 1. As mentioned above, the flow rate capability of the bag types is known so that an appropriate pump speed (or pump) can be set or chosen. The treated liquid exits the bag as indicated at 30 and accumulates in the collection basin 32, as seen in FIG. 1 indicated at 34. When all the contaminated liquid has been treated, or the collection basin is full, the user may dispense the liquid through the outlet port 36, which is seen in FIG. 4, either directly through the port 36 or through a hose or the like threaded onto the end thereof. Another aspect of the instant invention is that the treated liquid may be transported in the trailer to a second site for further filtering or chemical treatment.

There are many various materials that the apparatus 10 could be made out of, such as stainless steel, composite materials, plastic, or any combination of the three. The only requirement as to the material used is that it be of sufficient strength to withstand the stress engendered by the weight of the liquid in the collection basin.

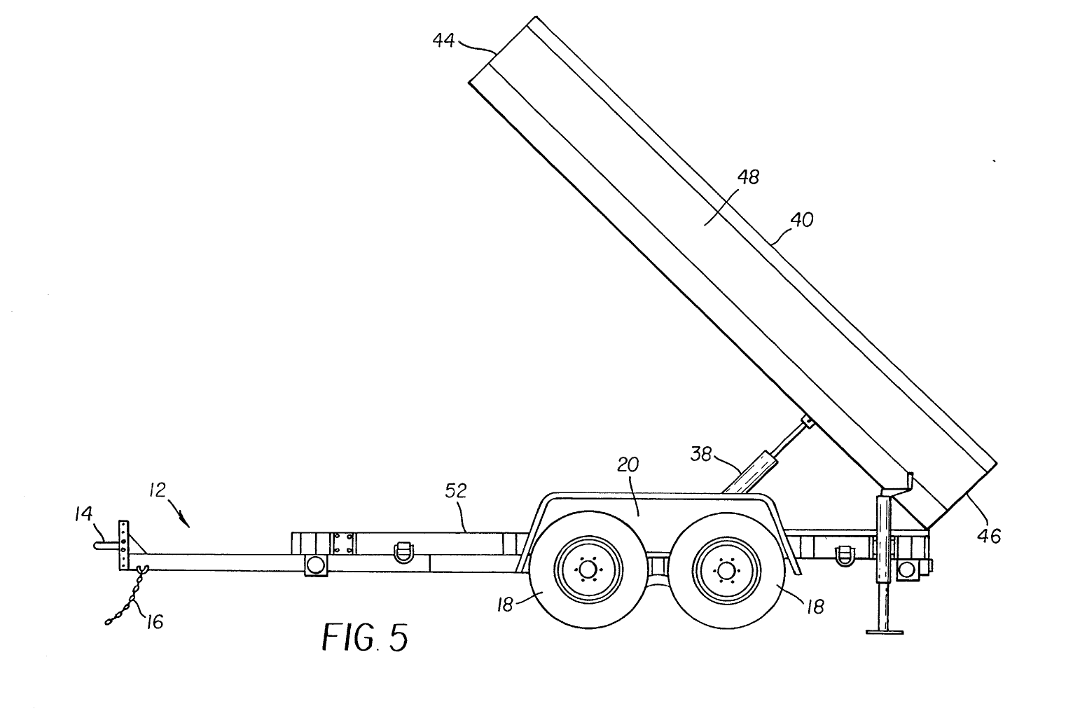

Another feature of the instant invention is the hydraulic ram, indicated at 38 and seen in FIG. 5. The ram 38 is a standard dump bed hydraulic ram. This feature allows the user to completely drain the trailer 10 through the tilting of the collection basin 32 away from the trailer bed portion 52 so that the liquid, through gravity, flows out of the outlet port 36. Additionally, this feature would assist the user to remove the wet filter bag 100 at the end of the filtering operation by allowing them to partially slide the bag 100 out toward the rear of the trailer 10.

It should be emphasized that the instant invention is not in any way limited to the embodiments as they are described above but encompasses all embodiments as described in the scope of then following claims.

What is claimed as being new and desired to be protected by Letters Patent of the United States is as follows:

1. A trailer and filter housing apparatus, said housing apparatus being towable behind a vehicle, said housing apparatus comprising:
a generally box-like structure having a front wall, a rear wall, an open top, a sealed bottom, and two side walls;
at least two wheels located proximate said side walls;
a trailer hitching means for attaching said generally box-like structure to a vehicle so that it can be towed, said trailer hitching means located on said front of said generally box-like structure;
a mesh screen disposed between said open top and said sealed bottom, said mesh screen defining a collection basin between said mesh screen and said sealed bottom;
an inlet port located on said front of said generally box-like structure;
an outlet port located on said rear of said generally box-like structure; and
tilting means to tilt said collection basin such that any liquid contained therein will, through gravity, tend to accumulate proximate said rear wall of said generally box-like structure, thus allowing the liquid to be decanted through said outlet port.

2. The apparatus according to claim 1, further including a trailer bed located beneath said generally box-like structure and wherein said tilting means comprises a hydraulic ram, said hydraulic ram being placed between said trailer bed and said generally box-like structure such that upon activation, said hydraulic ram will tilt said collection basin such that any liquid contained therein will, through gravity, tend to accumulate proximate said rear wall of said generally box-like structure, thus allowing the liquid to be decanted through said outlet port.

3. The apparatus according to claim 2, wherein said mesh screen consists of expanded metal with a mesh opening size between 0.4 and 1.7 inches.
